(19) United States
(12) Patent Application Publication
(10) Pub. No.: US 2017/0169297 A1
(43) Pub. Date: Jun. 15, 2017

(54) COMPUTER-VISION-BASED GROUP IDENTIFICATION

(71) Applicant: Xerox Corporation, Norwalk, CT (US)

(72) Inventors: Edgar A. Bernal, Webster, NY (US); Aaron M. Burry, Ontario, NY (US); Matthew A. Shreve, Webster, NY (US); Michael C. Mongeon, Walworth, NY (US); Robert P. Loce, Webster, NY (US); Peter Paul, Penfield, NY (US); Wencheng Wu, Webster, NY (US)

(73) Assignee: Xerox Corporation, Norwalk, CT (US)

(21) Appl. No.: 14/963,602

(22) Filed: Dec. 9, 2015

(51) Int. Cl. G06K 9/00; G06K 9/62; G06K 9/46; G06T 7/00

(52) U.S. Cl. CPC G06K 9/00771; G06T 7/0081; G06K 9/6267; G06K 9/4671

(57) ABSTRACT

A system and method of monitoring a region of interest comprises obtaining visual data comprising image frames of the region of interest over a period of time, analyzing individual subjects within the region of interest, the analyzing including at least one of tracking movement of individual subjects over time within the region of interest or extracting an appearance attribute of the individual subjects, and defining a group to include individual subjects having at least one of similar movement profiles or similar appearance attributes. The tracking movement includes detecting at least one of a trajectory of an individual subject within the region of interest, a dwell of an individual subject in at least one location within the region of interest, or an entrance or exit location within the region of interest.

### INCORPATION BY REFERENCE

The following reference, the disclosure of which is incorporated by reference herein in its entirety is mentioned:

U.S. application Ser. No. 13/933,194, filed Jul. 2, 2013, by Mongeon, et al., (Attorney Docket No. XERZ 202986US01), entitled “Queue Group Leader Identification”.

### BACKGROUND

Advances and increased availability of surveillance technology over the past few decades have made it increasingly common to capture and store video of retail settings for the protection of companies, as well as for the security and protection of employees and customers. This data has also been of interest to retail markets for its potential for data-mining and estimating consumer behavior and experience. For some large companies, slight improvements in efficiency or customer experience can have a large financial impact.

Retailers desire real-time information about customer traffic patterns, queue lengths, and check-out waiting times to improve operational efficiency and customer satisfaction. Several efforts have been made at developing retail-setting applications for surveillance video beyond well-known security and safety applications. For example, one such application counts detected people and records the count according to the direction of movement of the people. In other applications, vision equipment is used to monitor queues, and/or groups of people within queues. Still other applications attempt to monitor various behaviors within a reception setting.

One industry that is particularly heavily data-driven is quick serve restaurants (sometimes referred to as “fast food” restaurants). Accordingly, quick serve companies and/or other restaurant businesses tend to have a strong interest in numerous customer and/or store qualities and metrics that affect customer experience, such as dining area cleanliness, table usage, queue lengths, experience time in-store and drive-through, specific order timing, order accuracy, and customer response.

Other industries and/or entities are also interested monitoring various spaces for occupancy data and/or other metrics. For example, security surveillance providers are often interested in analyzing video for occupancy data and/or other metrics. Municipalities regularly audit use of public spaces, such as sidewalks, intersections, and public parks.

### BRIEF DESCRIPTION

It has been found that, in many settings, analyzing groups of people rather than each individual person is more desirable and/or yields additional and/or more pertinent information. For example, many retailers may be more interested in determining the number of shopping groups within their stores than the total number of people who frequent them. In particular, certain shopping experiences tend to be “group” experiences, such as the purchase of real estate, vehicles, high end clothing, or jewelry. The groups may include family members, friends, or other stakeholders in the purchase (for example: buying agents or lenders). Retailers or other selling agents desire to generate accurate sales “conversion rate” statistics where the number of actual sales is compared to the number of sales opportunities. However, in group shopping experiences, the number of sales opportunities is not equal to the number of individuals that enter the retail store, but equals the number of groups that enter the store. Thus automatically determining whether a person in a retailer is part of a group is critical to determining the number of groups in the store, and thus the number of selling opportunities and accurate sales conversion rates. Analyzing video for group behavior and/or experience present challenges that are overcome by aspects of the present disclosure.

In accordance with one aspect, a computer-implemented method of monitoring a region of interest comprises obtaining visual data comprising image frames of the region of interest over a period of time, analyzing individual subjects within the region of interest, the analyzing including at least one of tracking movement of individual subjects over time within the region of interest or extracting an appearance attribute of the individual subjects, and defining a group to include individual subjects having at least one of similar movement profiles or similar appearance attributes. The tracking movement includes detecting at least one of a trajectory of an individual subject within the region of interest, a dwell of an individual subject in at least one location within the region of interest, or an entrance or exit location within the region of interest.

In accordance with another aspect, a non-transitory computer-readable medium having stored thereon computer-executable instructions for monitoring a region of interest, the instructions being executable by a processor and comprising obtaining visual data comprising image frames of the region of interest over a period of time, analyzing individual subjects within the region of interest, the analyzing including at least one of tracking movement of individual subjects over time within the region of interest or extracting an appearance attribute of the individual subjects, and defining a group to include individual subjects having at least one of similar movement profiles or similar appearance attributes. The tracking movement includes detecting at least one of a trajectory of an individual subject within the region of interest, a dwell of an individual subject in at least one location within the region of interest, or an entrance or exit location within the region of interest.

In accordance with yet another aspect, a system for monitoring a customer space comprises at least one optical sensor for obtaining visual data corresponding to the customer space, and a central processing unit including a processor and a non-transitory computer-readable medium having stored thereon computer-executable instructions for monitoring a customer space executable by the processor, the instructions comprising obtaining visual data comprising image frames of the region of interest over a period of time, analyzing individual subjects within the region of interest, the analyzing including at least one of tracking movement of individual subjects over time within the region of interest or extracting an appearance attribute of the individual subjects, and defining a group to include individual subjects having at least one of similar movement profiles or similar appearance attributes. The tracking movement includes detecting at least one of a trajectory of an individual subject within the region of interest, a dwell of an individual subject in at least one location within the region of interest, or an entrance or exit location within the region of interest.

In various embodiments, the analyzing can include generating feature models for each individual subject. The generating feature models can include training at least one statistical classifier on at least one set of features extracted from labeled data and using the at least one trained classifier on like features extracted from the obtained data. The statistical classifier can include at least one of a linear support vector machine, a non-linear support vector machine, a decision tree, a clustering algorithm, a neural network, or a random forest. The set of features can include Local Binary Patterns (LBP), color histograms, Histogram Of Gradients (HOG), Speeded Up Robust Features (SURF), or Scale Invariant Feature Transform (SIFT).

The tracking movement can include tracking movement using at least one of mean-shift, cam-shift, particle filter, Kanade-Lucas-Tomasi (KLT), or Circulant Structure Kernel (CSK) tracking algorithms. The detecting a trajectory of an individual subject within the region of interest includes detecting at least one of velocity, angle or length of a path taken through the region of interest. The dwell can include a location and duration. The method can further include calculating an affinity score for pairs of individual subjects, the affinity score representative of the likelihood that both individual subjects belongs to a particular group, and/or applying a transitive affinity function to increase or decrease an affinity score of a pair of individual subjects based on each individual subject's affinity score with a third individual subject. The calculating an affinity score can include measuring a similarity between trajectories of at least two individuals, including comparing at least one of velocity, angle or length of a path taken through the region of interest, entrance/exit locations, or dwell.

### BRIEF DESCRIPTION OF THE DRAWINGS

FIG. 1 is a block diagram of an exemplary system in accordance with the present disclosure;

FIG. 2 is a block diagram of another exemplary system in accordance with the present disclosure;

FIG. 3 is a flowchart of an exemplary method in accordance with the present disclosure;

FIG. 4 is an overhead view of an exemplary region of interest illustrating trajectories of two individual subjects;

FIG. 5 is the view of FIGURE including dwell information for the individual subjects;

FIG. 6A is an exemplary image frame of two individuals entering a retail setting at a common time; and

FIG. 6B is an exemplary image frame of two individuals exiting a retail setting at a common time.

### DETAILED DESCRIPTION

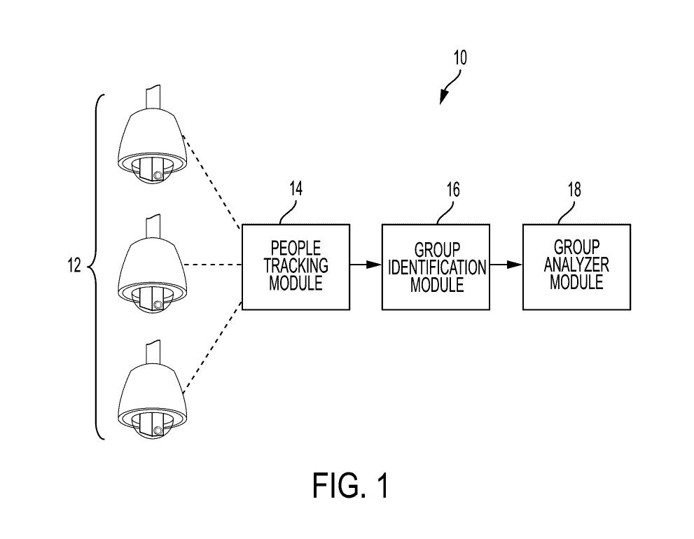

With reference to FIG. 1, a system 10 in accordance with the present disclosure comprises a plurality of modules, illustrated schematically in FIG. 1. The system 10 includes a video capture module 12 that acquires visual data (e.g., video frames or image frames) of a region or regions of interest (ROI—e.g., a customer space, retail establishment, restaurant, public space, etc.) The video capture module is illustrated as a plurality of cameras (e.g., optical sensors), which may be surveillance cameras or the like. A people tracking module 14 receives the visual data from the cameras and both identifies unique individuals within the customer space and tracks the identified individuals as they move within the space. It should be appreciated that the identity of the unique individuals is not required to be determined by the people tracking module 14. Rather, it is sufficient that the people tracking module 14 merely be able to distinguish between unique individuals within the ROI. For example, a family may enter the customer space and walk to a counter to place a food order, then proceed to a dining table or other location to dine. As another example, a pair of people may enter a store, browse merchandise at different locations within the store, and reconvene at a checkout location. A group identification module 16 identifies which individuals belong to a group based on one or more of a plurality of characteristics. Such characteristics can include, for example, similar trajectory, common dwell, common enter/exit locations/times, common appearance. A group analyzer module utilizes information from both the people tracking module 14 and the group identification module 16 to generate statistics of each identified group.

In an exemplary embodiment, the video capture module 12 can comprise at least one surveillance camera that captures video of an area including the ROI. No special requirements in terms of spatial or temporal resolutions are needed for most applications. Traditional surveillance cameras are typically IP cameras with pixel resolutions of VGA (640×480) and above and frame rates of 15 fps and above. Such cameras are generally well-suited for this application. Higher resolution cameras can also be utilized, as well as cameras having other capabilities such as infrared (IR), thermal imaging, and Pan/Tilt/Zoom (PTZ) cameras, for example.

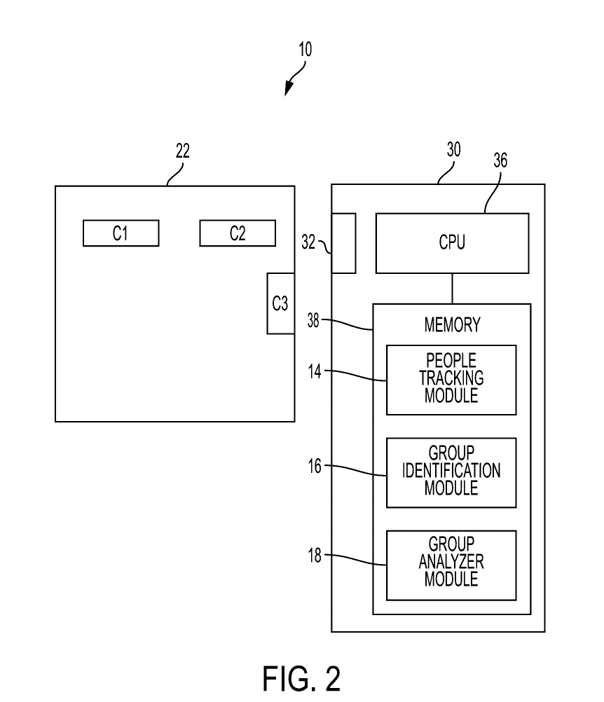

In FIG. 2, the exemplary system 10 is illustrated in block diagram form in connection with a customer space 22. It will be appreciated that customer space 22 is exemplary, and that the system 10 can be implemented in virtually any location or setting (e.g., public spaces, etc.). In the exemplary embodiment, video capture module 12 is shown as a plurality of cameras C1, C2 and C3. However, any number of cameras can be utilized.

The cameras C1, C2 and C3 are connected to a computer 30 and supply visual data comprising one or more image frames thereto via a communication interface 32. It will be appreciated that the computer 30 can be a standalone unit configured specifically to perform the tasks associated with the aspects of this disclosure. In other embodiments, aspects of the disclosure can be integrated into existing systems, computers, etc. The communication interface 32 can be a wireless or wired communication interface depending on the application. The computer 30 further includes a central processing unit 36 coupled with a memory 38. Stored in the memory 38 are the people tracking module 14, the group identification module 16, and the group analyzer module 18. Visual data received from the cameras C1, C2 and C3 can be stored in memory 38 for processing by the CPU 36 in accordance with this disclosure.

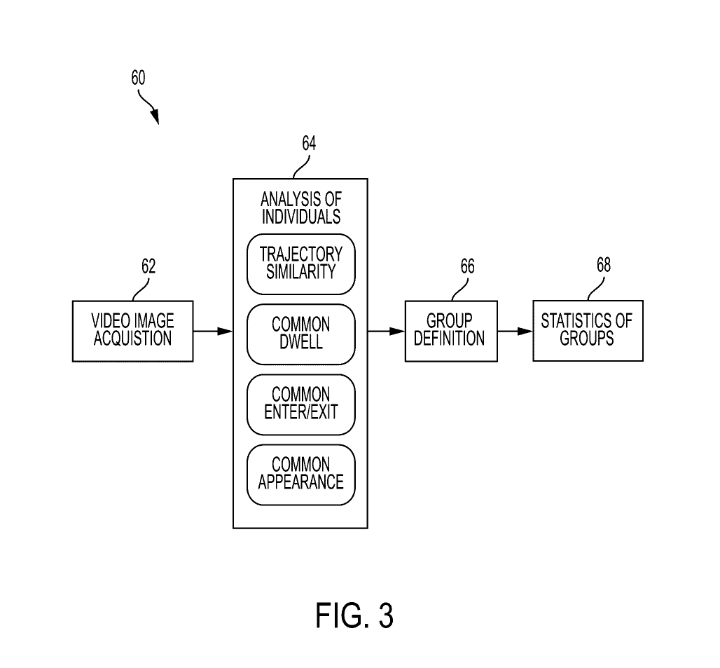

FIG. 3 is an overview of an exemplary method 60 in accordance with the present disclosure. In process step 62, video is acquired using common approaches, such as via video cameras in a surveillance setting for retail, transportation terminals, municipal parks, walkways, and the like. Video can also be acquired from existing public or private databases, such as YouTube® and surveillance DVRs. In process step 64, video segments are analyzed for behavior of individuals in the segments, and how the behaviors correlate to the behaviors of other individuals. The degree of correlation or similarity is used to determine if individuals belong to a common group and, in process step 66, one or more groups are defined.

Various exemplary methods for determining correlations are described in detail below, and include, among others, i) tracking and determining if trajectories of individuals are correlated in space and time, ii) detecting individuals as they enter a scene and detecting when they leave the scene, and individuals with common enter/exit times are defined as a group, iii) detecting the presence of individuals, and determining the time that they dwell at a location—individuals with common dwell are defined as a group, iv) appearance matching between individuals, for detecting groups such as teams wearing a team shirt or uniform. Additional statistical analysis can be performed, in process step 68, on the collection of groups identified over time, such as distribution of group size over time, mean group size, etc.

With regards to process step 64, various exemplary methods will now be described for analyzing individuals within a space to determine group status.

Trajectory Similarity

Trajectories of individuals can be determined and, if trajectories between individuals are sufficiently correlated in time and space, each of the individuals can be considered to be members of a common group. Trajectories of individuals can be determined, for example, by performing individual person detection via computer vision techniques. For instance, one exemplary method of human detection from images includes training at least one statistical classifier on at least one set of features extracted from labeled data (e.g., data labeled by humans), and then using the trained classifier on like features extracted from new images. The statistical classifier can include at least one of a linear support vector machine, a non-linear support vector machine, a decision tree, a clustering algorithm, a neural network, or a random forest. Other classifier-based human detection techniques can be used (e.g., facial detection techniques). Motion-based approaches that perform foreground segmentation can also be used for detecting individuals. For instance, heuristics (e.g., height and width aspect constraints) can be applied to motion blobs (i.e., clusters of foreground pixels) to detect human motion. In one exemplary method, repeat detections can be matched to form trajectories using minimum distances between repeat detections. Another technique may be to combine a human motion-based segmentation approach with one of the aforementioned classification-based human detection techniques.

Once individuals are detected, their trajectories across time can be determined with the aid of video-based object tracking algorithms. These include, but are not limited to mean-shift, cam-shift, particle filter, Kanade-Lucas-Tomasi (KLT), Circulant Structure Kernel (CSK) tracking, among others.

Although the people tracking method described above has the order of detecting individuals followed by tracking them, the method can be done in reverse order as well. For example, in some settings it may be beneficial to first track objects, human or not, (e.g., initiated by motion-based method) and then confirm whether a particular trajectory is of human. The reason for doing human-confirmation later is that it often requires higher spatial resolution for a vision algorithm to confidently determine whether an object been tracked is human or not. With that in mind, it might be beneficial to track objects first and then confirm whether it is of human or not at the time when highest confidence can be yielded (e.g,, at close up).

Once individual trajectories are aggregated, the spatial and temporal correlation between them can be measured via multidimensional time series analysis techniques such as Dynamic Time Warping and the like.

Alternatively, features from the extracted trajectories (including length, velocity, angle and the like) can be extracted, and similarities can be measured in the resulting feature space. Pair-wise trajectories that are found to be more similar than a given threshold are determined to belong to the same group of people. Note that for the common situation of batch analysis after video is collected (not in ‘real-time’) trajectory similarity can use trajectory information that is derived from trajectories defined forwards in time or backwards in time.

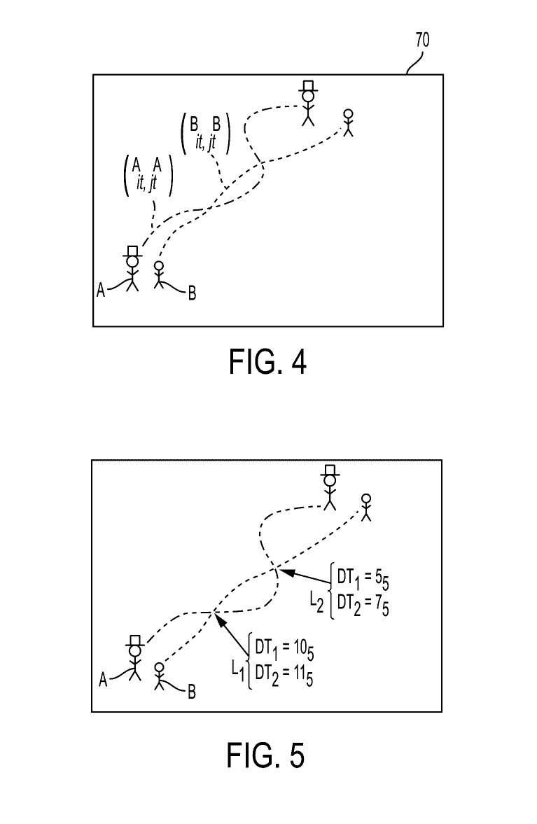

FIG. 4 illustrates two trajectories (iₜ^{A},jₜ^{A}) and (iₜ^{B},jₜ^{B}) of two subjects within a space 70. Although the trajectories (iₜ^{A},jₜ^{A}) and (iₜ^{A},jₜ^{B}) are not identical, provided they are more similar than a given threshold, the subjects will be identified as members of a common group. First, to aid in robustness of the decision of trajectory similarity, smoothing techniques are optionally applied such as convolution, curve fitting, AR (Auto-Regression), MA (Moving Average) or ARMA etc., to smooth the tracked trajectories. The levels of smoothing depend on the performance/characteristics of the people tracking module 14, thus it is somewhat application/module dependent. For the people tracking module mentioned above and frame rates of 30 frames/sec, temporal smoothing over ˜4 sec periods is typically sufficient. Many smoothing methods can work for this task. However, some may be more suited than others depending on the time-scale used in the module. Once the trajectories are smoothed, relevant features are extracted from the smoothed trajectories for later use. Of particular interest is the automated detection of at least two persons with similar trajectories. Hence, relevant features are extracted from single and multiple trajectories. In particular, one approach extracts temporal features of individual position, and computes relative distances between persons of interest. The features can be extracted in an offline or online manner depending on the application, and these options affect several choices in implementing this module algorithm. Using these two trajectories as an example, let
smoothed trajectory, (iₜ^{A},jₜ^{A}), t=t_{S}^{A}, . . . , t_{E}^{A} correspond to person A
smoothed trajectory, (iₜ^{B},jₜ^{B}), t=t_{S}^{B}, . . . , t_{E}^{B} correspond to person B
   where (i, j) are the row and column pixel coordinates, respectively, and t is time (or frame number), with S and E denoting start and end times respectively for a given person. Then the Trajectory Interaction Features (TIFs) between A and B are three temporal profiles of the length equal to the overlap time duration of their trajectories. In short, the TIFs are the positions, velocities, of both persons, as well as the distance between them during the time periods that both are being tracked. In the case where two persons have never co-appeared in the videos, no further analysis is performed because the overlap time duration is zero.
Overlap time duration min(t_{E}^{A},t_{E}^{B})−max(t_{S}^{A},t_{S}^{B}),

TIFs

position of person A at time t, pₜ^{A}=(iₜ^{A},jₜ^{A}),

position of person B at time, pₜ^{B}=(iₜ^{B},jₜ^{B}),
relative distance between the persons at time t dₜ^{AB}=\sqrt{(iₜ^{A}−iₜ^{B})²+(jₜ^{A}−jₜ^{B})²}.

Let Gₜ^{AB}, t=max(t_{S}^{A}+1, t_{S}^{B}+1), . . . , min(t_{E}^{A},t_{E}^{B}) be the decision vector that indicates if the trajectories are associated with a group (G=1) or not (G=0).

$${G}_{t}^{AB} = \{ \begin{matrix}1 & if {d}_{t}^{AB} < {η}_{d} ( FOV \\ 0 & otherwise\end{matrix} ,$$

The vector may be post-processed (e.g., by applying temporal filtering with a median filter) to remove detection of low confidence events or outliers. Note that the proximity threshold η_{d} depends or is a function of the Field Of View (FOV), because views can have significantly different scales. The algorithm can be configured to accommodate views of significantly different scale in order to be robust across various fields of view in practice. In absolute units the threshold can be interpreted as a distance of 2 to 4 meters, for example. A camera calibration in field for all the cameras that operate the trajectory analysis can be performed so the algorithms can operate in physical absolute units. Alternatively, simple approximation can be done without camera calibration due to information gained by the system as it detects and tracks persons. The collected sizes of tracked humans (e.g., heights or widths) can be used as a simple surrogate for adjusting thresholds from one camera view to another.

In an alternative embodiment, the similarity between trajectories can be computed via a dynamic time warping (DTW) function. The DTW function may consider the overlapping sub-trajectories of a pair of trajectories and apply a temporal warping of one of the sub-trajectories to best align with the other sub-trajectory. The dissimilarity between the sub-trajectories can be computed as the cumulative distance between the warped sub-trajectory and the other sub-trajectory. Specifically, let (iₜ^{A},jₜ^{A}) be the sub-trajectory that is temporally warped into (iₜ^{A′},jₜ^{A′}) to best match sub-trajectory (iₜ^{B},jₜ^{B}). Then, if (iₜₖ^{A′}, jₜₖ^{A′}) is the warped sub-trajectory point that best matches sub-trajectory point (iₜₖ^{B},jₜₖ^{B}), and that was obtained by warping(iₜₖ^{A},jₜₖ^{A}), then the individual distance between the two points can be computed as a function of tₗ−tₖ, for example, as |tₗ−tₖ| or (tₗ−tₖ)². The cumulative distance between sub-trajectories A and B is the sum of these individual distances across every point in the sub-trajectories. If the cumulative distance is smaller than a given threshold, then the persons to which trajectories A and B correspond may be determined to belong to the same group.

In alternative implementations, other similarity or dissimilarity metrics between trajectories or sequences can be implemented. These include metrics based on the longest common subsequence, the Fréchet distance, and edit distances.

In some scenarios, the volume of individuals moving through a scene can change markedly with time of day. Consider, for example, the large rush of people during the lunch peak at a quick serve restaurant versus 10 p.m. at the same location. To be more robust to these types of environmental considerations, in some embodiments the threshold for correlation between trajectories to be considered part of the same group is adjusted based on time of day information. That is, during peak times when there are multiple trajectories it may be desirable to require greater correlation between trajectories to improve accuracy.

Common Dwell

Persons within a group tend to pause their movement, or dwell, at a specific location at a similar time. Determining common dwell time of individuals can be used to assign those individuals to a group. While the dwell time of an individual can be extracted from his/her trajectory over time (e.g., by tracking the individual as illustrated above and identifying stationary or quasi-stationary portions in the trajectory), alternative techniques can be utilized.

In one embodiment, a long-term background model is maintained and compared with background models constructed at different time scales. A background model is a collection of pixel-wise statistical models that describe individual pixel behavior across time; the length of the pixel history used to construct the background model can be adjusted depending on the application. For example, in order to identify people and/or groups of people with a dwell time longer than a threshold T1 seconds, two background models can be constructed: a long-term background model BL of length T0>>T1 seconds and a short-term background model BS of length T1 seconds. The intersection between both background models, denoted as BL ∩ BS, includes the set of pixel-wise statistical models that are highly overlapping with each other (e.g., as measured by a divergence metric such as the Bhattacharyya or Mahalanobis distances) and describes the portion of the background that has remained stationary for the longest period of time considered. The pixel-wise models in BS that differ from their corresponding pixel-wise models in BL, that is, the pixel-wise models in BS\(BL ∩ BS), denote portions in the video that have not remained stationary for at least T0 seconds. A visual representation of the models in BS\(BL ∩ BS) can be obtained, for example, by extracting the mode or the median (in general, any single statistic) of each of the models and displaying the resulting image. Human-like shapes in the image thus obtained will represent individuals with dwell times longer than T1 seconds, and so the output of a human detector on the image followed with person clustering by proximity will provide a good representation of groups of people with the desired dwell time.

FIG. 5 illustrates the same subjects as FIG. 4, but with dwell times DT1/DT2 calculated at two different locations L1 and L2. At L1, DT1 is 10 s and DT2 is 11 s. At L2, DT1 is 5 s and DT2 is 7 s. Because the subjects dwell for similar amounts of time at two common locations, the subjects may be identified as members of a common group. It will be appreciated that the dwell times occur during the same time and/or overlap in time.

Common Enter/Exit Location and/or Time

Video frames encompassing a spatial region or spatial regions of interest can be defined within video frames. Individuals within a group tend to enter and exit those regions at similar times. There are several different computer vision techniques that can be used to determine the arrival and exit times of individuals within a scene, or across several scenes contained in a camera network. In one embodiment, the algorithm can store the arrival time of an individual and initialize a tracking algorithm that will determine the frame by frame location of each individual as they move throughout the scene(s), until they eventually exit (at this point, the persons exiting time/frame is stored). Specific algorithms that could accomplish this task include motion-based tracking that uses optical flow or foreground/background segmentation, or appearance-based trackers, including mean-shift tracking, the Kanade-Lucas-Tomasi (KLT) tracker, or the Circulant Structure Kernel (CSK) tracker.

Once the track of each individual is known (and therefore their corresponding entrance and exit times), analysis can be performed that finds individuals with common entrance and exit times. For example, if the difference between two individuals' start and exit times is less than some pre-defined threshold, then a decision can be made that the individuals belong in the same group. This process can be repeated for each person, thus forming larger groups where all members share similar entrance and exit times.

As a further filtering of these group candidates, the spatial distance between individuals after entry/exit can also be examined. Individuals entering at the same time but who then follow markedly different paths (i.e., diverge spatially) are likely not part of the same common group, but just happened to enter at roughly the same time. This type of analysis could be more important in scenarios/timeframes wherein the volume of people entering and exiting is extremely high (e.g., the lunch rush at a quick serve restaurant). In one embodiment, the threshold distance between individual trajectories could be a function of time to better handle these time varying environmental conditions.

In another embodiment, re-identification across different regions within the same view (or across different camera views) may be performed without the need for frame by frame tracking (i.e., without trajectory information). For example, an appearance model (i.e., a soft biometric) and timestamp can be stored for each individual as they enter a retail environment. Some example appearance models can include a feature representation of any or all portion(s) of their body (e.g., face, upper body, clothing, lower body, etc.)

In one exemplary embodiment, a person is detected using a combination of a face and upper body region detector. Color (CSK, Hue Histograms) and texture (Local Binary Patterns—LBP) features are then extracted from both of these detected regions and stored along with a timestamp of when they entered. Similarly, each person leaving the scene is detected, and the same type of color and texture features are extracted from the detected face and upper body regions, as well as their exit timestamp. Then, all possible pairs of detected persons that were detected at both the entrance and exit are compared (each person detected at the entrance is compared with each person detected at the exit) over some fixed time interval and given a match score. The entrance and exit time stamps for each pair of individuals with a match score above a pre-defined threshold (i.e., it is the same person detected at both the entrance and exit) can then be used to determine the length of time the person was within the retail environment. Lastly, clustering that is based on the entrance time and the total amount of time each individual was in the retail environment is performed, in order to determine groups.

Common Appearance

Teams, clubs and other groups often wear some common apparel, such as a tee shirt, hat etc., of the same color. Team members can be assigned to a group based on the similarity of appearance of some type of apparel. The similarity in the appearance of the individuals can be quantitatively measured, for example, by computing a color histogram of the image area corresponding to each of the individuals. In one embodiment, the mode of the histogram can be computed and used as being indicative of a predominant color in the clothing of the individual. If the representative color of multiple individuals matches, they can be assigned to a single group. Note that color spaces other than RGB (e.g., Lab, HSV, and high-dimensional discriminative color spaces) can be used to account for the effects of non-homogeneous illumination. In alternative embodiments, multiple color histograms of each individual can be extracted according to partitions dictated by decomposable models (e.g., one histogram for the head, one for the torso and one for the legs). An appearance match can be then established if matches between certain sets of individual histograms are verified across individuals.

It is to be appreciated that a combination of two or more of the methods described above can be used to identify groups of people, with potentially improved robustness compared to the use of a single technique. For example, while multiple individuals can be deemed to be wearing like color clothing, they could still belong to different groups, in which case the use of appearance and dwell time or trajectory analysis would correctly assign them to separate clusters of people.

Specific Congregation Points Within a Store

The metrics and calculations defined above for determining if an individual is part of a group (Trajectory Similarity, Common Dwell, Common Entry/Exit, and Common Appearance) may be calculated at specific locations within the store called “Congregation Points”. The Congregation Points are locations within the store (or other region of interest) where groups, or sub groups, gather together to view a specific merchandise item (or other feature). For example, in a car show room, this may be the cars on display or the salesperson's desk. Members of the same group may enter the store together, split off into sub-groups which go to different congregation points, then join back together at another congregation point. Further members of the same group may enter the store at different times, then meet together at a congregation point (e.g., family members arriving for dinner at a restaurant at different times). The metrics and calculations defined above may be calculated in sequence as these people journey through the retail store.

Affinity Score

An ‘Affinity Score’ can be defined between two individuals in a retail store which quantifies the system's belief that the two individuals are part of the same group. For example, an Affinity Score of 1.0 may mean that the system strongly believes that the two individuals belong to the same group, while an Affinity Score of 0.0 may mean that the system strongly believes that the two individuals do not belong to the same group. The Affinity Scores may be arranged into an ‘Affinity Matrix’ which is a symmetric matrix which compactly describes the system's belief in which individuals may or may not be part of groups with each other. The affinity score is calculated based on the trajectory, dwell, exit/entry, and appearance attributes described above. In each attribute, above, a distance metric is defined which is used to describe the similarity of two subjects relative to that attribute. The affinity score aggregates the similarity from all attributes to generate a score which represents subjects belonging together in the same group. The affinity score is calculated using the distance metric prior to any threshold being applied. The following equation describes the affinity score: α^{A,B}=f(D_{T}^{A,B,t},D_{d}^{A,B},D_{E}^{A,B,n,x},D_{P}^{A,B}) where α is the affinity score, D are distance metrics, T is trajectory, d is dwell, E is exit/entry, p is appearance, A is subject 1, B is subject 2, t is a time period, n is an entry time, and x is an exit time. Note that the attributes can be weighted relative to each other in the affinity score calculation: α^{A,B}=w_{T}D_{T}^{A,B,t}+w_{d}D_{d}^{A,B}+w_{E}D_{E}^{A,B,n,x}+w_{P}D_{P}^{A,B}.

Affinity Score Changing with Time

Based on the metrics and calculations described above (Trajectory Similarity, Common Dwell, Common Entry/Exit, and Common Appearance), and calculated over time during an individual's journey through a retail store, the individual's Affinity Score relative to other individuals may increase or decrease. The model which takes as input the metrics and calculations described above and generates the affinity score may be defined through prior knowledge or may be learned using a machine learning method using supervised learning and video data that has been labeled by a human in terms of the individuals belonging to groups. Note that since in many applications group statistics are generated in batch processing after video data is collected (not in real-time), affinity score changes can occur by processing forward in time and/or backward in time.

Transitive Affinity

If the system strongly believes that individual A is part of a group with individual B who the system also believes strongly is part of a group with individual C, then the system increases the affinity score between individual A and individual C. Similarly if the system strongly believes that individual A is not part of a group with individual B who the system also believes strongly is part of a group with individual C, then the system decreases the affinity score between individual A and individual C.

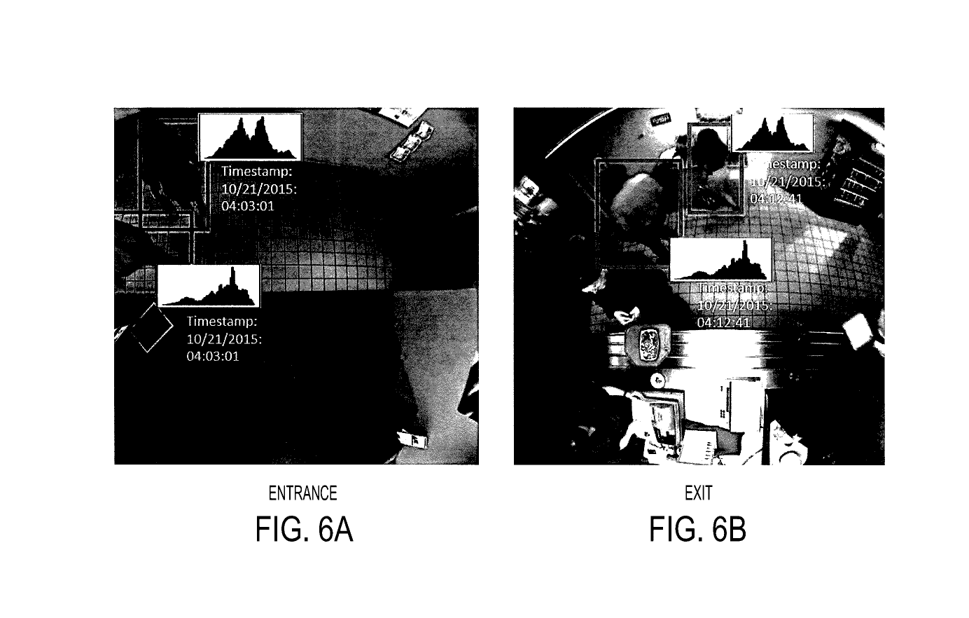

Turning to FIGS. 6A and 6B, exemplary histograms and timestamps are overlayed on respective image frames depicting two people entering and exiting a retail environment at similar times. It will be appreciated that the histograms can be compared to identify the individuals. Using the common timestamps of the entrance and exit of each individual, the system and method of the present disclosure can assign each of the individuals to a common group. In cases where the timestamps are very close or identical (as in this exemplary case), the likelihood that the individuals belong to the same group is high. In one embodiment, individuals with the same or similar entrance and exit times can be determined, and then further processing can be performed to determine matches between unique individuals having the same or similar entrance and exit times.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method of monitoring a region of interest comprising:
obtaining visual data comprising image frames of the region of interest over a period of time;
analyzing individual subjects within the region of interest, the analyzing including at least one of tracking movement of individual subjects over time within the region of interest or extracting an appearance attribute of the individual subjects; and
defining a group to include individual subjects having at least one of similar movement profiles or similar appearance attributes;
wherein the tracking movement includes detecting at least one of a trajectory of an individual subject within the region of interest, a dwell of an individual subject in at least one location within the region of interest, or an entrance or exit location within the region of interest.

2. The computer-implemented method of claim 1, wherein analyzing includes generating feature models for each individual subject.

3. The computer-implemented method of claim 2, wherein the generating feature models includes training at least one statistical classifier on at least one set of features extracted from labeled data and using the at least one trained classifier on like features extracted from the obtained data.

4. The computer-implemented method of claim 3, wherein the statistical classifier includes at least one of a linear support vector machine, a non-linear support vector machine, a decision tree, a clustering algorithm, a neural network, or a random forest.

5. The computer-implemented method of claim 3, wherein the set of features includes at least one of Local Binary Patterns (LBP), color histograms, Histogram Of Gradients (HOG), Speeded Up Robust Features (SURF), or Scale Invariant Feature Transform (SIFT).

6. The computer-implemented method of claim 1, wherein the tracking movement includes tracking the movement of an individual using at least one of mean-shift, cam-shift, particle filter, Kanade-Lucas-Tomasi (KLT), or Circulant Structure Kernel (CSK) tracking algorithms.

7. The computer-implemented method of claim 1, wherein the dwell includes a location and duration of stay.

8. The computer-implemented method of claim 1, further comprising calculating an affinity score for pairs of individual subjects, the affinity score representative of the likelihood that both individual subjects belongs to a particular group.

9. The computer-implemented method of claim 8, wherein the calculating an affinity score includes measuring a similarity between trajectories of at least two individuals, including comparing at least one of velocity, angle or length of a path taken through the region of interest, entrance/exit locations, or dwell.

10. The computer-implemented method of claim 8, further comprising applying a transitive affinity function to increase or decrease an affinity score of a pair of individual subjects based on each individual subject's affinity score with a third individual subject.

11. A non-transitory computer-readable medium having stored thereon computer-executable instructions for monitoring a region of interest, the instructions being executable by a processor and comprising:
obtaining visual data comprising image frames of the region of interest over a period of time;
analyzing individual subjects within the region of interest, the analyzing including at least one of tracking movement of individual subjects over time within the region of interest or extracting an appearance attribute of the individual subjects; and
defining a group to include individual subjects having at least one of similar movement profiles or similar appearance attributes;
wherein the tracking movement includes detecting at least one of a trajectory of an individual subject within the region of interest, a dwell of an individual subject in at least one location within the region of interest, or an entrance or exit location within the region of interest.

12. The non-transitory computer-readable medium as set forth in claim 11, wherein analyzing includes generating feature models for each individual subject.

13. The non-transitory computer-readable medium as set forth in claim 12, wherein the generating feature models includes training at least one statistical classifier on at least one set of features extracted from labeled data and using the at least one trained classifier on like features extracted from the obtained data.

14. The non-transitory computer-readable medium as set forth in claim 13, wherein the statistical classifier includes at least one of a linear support vector machine, a non-linear support vector machine, a decision tree, a clustering algorithm, a neural network, or a random forest.

15. The non-transitory computer-readable medium as set forth in claim 13, wherein the set of features includes at least one of Local Binary Patterns (LBP), color histograms, Histogram Of Gradients (HOG), Speeded Up Robust Features (SURF), or Scale Invariant Feature Transform (SIFT).

16. The non-transitory computer-readable medium as set forth in claim 11, wherein the tracking movement includes tracking the movement of an individual using at least one of mean-shift, cam-shift, particle filter, Kanade-Lucas-Tomasi (KLT), or Circulant Structure Kernel (CSK) tracking algorithms.

17. The non-transitory computer-readable medium as set forth in claim 11, wherein the dwell includes a location and duration of stay.

18. The non-transitory computer-readable medium as set forth in claim 11, further comprising calculating an affinity score for pairs of individual subjects, the affinity score representative of the likelihood that both individual subjects belongs to a particular group.

19. The non-transitory computer-readable medium as set forth in claim 18, wherein the calculating an affinity score includes measuring a similarity between trajectories of at least two individuals, including comparing at least one of velocity, angle or length of a path taken through the region of interest, entrance/exit locations, or dwell.

20. The non-transitory computer-readable medium as set forth in claim 11, further comprising applying a transitive affinity function to increase or decrease an affinity score of a pair of individual subjects based on each individual subject's affinity score with a third individual subject.

21. A system for monitoring a customer space comprising:
at least one optical sensor for obtaining visual data corresponding to the customer space; and
a central processing unit including a processor and a non-transitory computer-readable medium having stored thereon computer-executable instructions for monitoring a customer space executable by the processor, the instructions comprising:
obtaining visual data comprising image frames of the region of interest over a period of time;
analyzing individual subjects within the region of interest, the analyzing including at least one of tracking movement of individual subjects over time within the region of interest or extracting an appearance attribute of the individual subjects; and
defining a group to include individual subjects having at least one of similar movement profiles or similar appearance attributes;
wherein the tracking movement includes detecting at least one of a trajectory of an individual subject within the region of interest, a dwell of an individual subject in at least one location within the region of interest, or an entrance or exit location within the region of interest.

22. The system as set forth in claim 21, wherein analyzing includes generating feature models for each individual subject.

23. The system set forth in claim 22, wherein the generating feature models includes training at least one statistical classifier on at least one set of features extracted from labeled data and using the at least one trained classifier on like features extracted from the obtained data

24. The system as set forth in claim 21, wherein the instruction further includes applying a transitive affinity function to increase or decrease an affinity score of a pair of individual subjects based on each individual subject's affinity score with a third individual subject.
